(19) United States
(12) Patent Application Publication
(10) Pub. No.: US 2026/0115869 A1
(43) Pub. Date: Apr. 30, 2026

(54) RACHETING ADAPTER MODULE FOR ADJUSTABLE WRENCHES

(71) Applicant: Robin PENG, Sandy, UT (US)

(72) Inventor: Robin PENG, Sandy, UT (US)

(21) Appl. No.: 18/291,132

(22) PCT Filed: Jul. 21, 2022
(86) PCT No.: PCT/US22/74030

§ 371 Date: Jan. 30, 2025

Related U.S. Application Data
(60) Provisional application No. 63/224,846, filed on Jul. 22, 2021.

(51) Int. Cl. B25B 13/46; B25B 13/14; B25B 23/00

(52) U.S. Cl. CPC B25B 13/465; B25B 13/14; B25B 23/0028

(57) ABSTRACT

One modular ratchet adapter for use with an opposed jaw tool features a wishbone armature (140), (150) supporting a ratchet head (160) while being centered within an elastomeric grip (110). The grip (100) is secured within two jaws of a tool, such as adjustable wrench (200), which interface about a trough (130) defined by the grip (110). An alternate modular ratchet adapter may feature an adapter module and a custom grip housing designed to interface with a given brand and size of adjustable wrench (200). This allows a singular ratchet adapter design to be manufactured while the grip housing may be more economically produced to enhance utility across multiple platforms. Either ratchet adapter may be used between the jaws (210, 230) of a given adjustable wrench (200) or other tool with opposed jaws.

### CROSS-REFERENCES TO RELATED APPLICATIONS

The present invention claims priority to prior filed U.S. Application No. 63/224,846, filed on Jul. 22, 2021, and incorporates the same by reference herein in its entirety.

### TECHNICAL FIELD OF THE INVENTION

The present invention relates to the field of hand tools and more particularly relates to a modular adapter to enhance the utility of an adjustable wrench.

### BACKGROUND ART

The concept of having a single tool that performs a variety of functions is an old one. Historically, pocketknives, can-openers and eating utensils were incorporated into a single unit as an early survival tool. Multi-purpose tools were later introduced catering to outdoor recreational activities and do-it-yourself repair alike. A classic example of a multiple purpose tool in the modern era is the SWISS ARMY KNIFE by VICTORINOX. This knife has a reputation for having multiple tools contained in the small profile of a single pocketknife. In so doing, a user may have a perfect tool for any job he or she may encounter. However, the tools in the knife must fit within the confines of the tool handle. As such, the expense of versatility comes at the price of sacrificing functionality and sound ergonomics, limiting the effectiveness of the tools as a whole and limits the type of tools that may be incorporated into the knife profile. Similarly, multiple standard tools may also be incorporated into a single profile. One recent combination is the incorporation of a ratchet into a adjustable wrench. A ratchet head is usually incorporated at the butt end of the wrench and in so do doing a single tool can accomplish multiple tasks. However, such wrenches are typically made to ergonomically accommodate one tool or the other and the permanent addition of a ratchet head at the butt of the tool is cumbersome.

In a prior application, MODULAR MULTIPLE-USE TOOL, filed Mar. 30, 2020, as application number PCT/US20/25827 (which is incorporated herein by reference in its entirety), the Applicant introduced a ratcheting module capable of fitting within the movable jaws of the disclosed tool. This module was a ratcheting head onto which numerous attachments, whether bits or sockets, could be fastened. Thereby turning the multiple use tool into a desired ratchet driver. However, the prior disclosure only provides for use of this module with the disclosed tool. Until now, there was no way to adapt this ratcheting head to another tool, such as an adjustable wrench. It should be noted that adapting any module to fit inside the jaws of an adjustable wrench is problematic because different manufacturers manufacture their wrenches with slightly different profiles, and even different adjustable wrenches from the same manufacturer will have significant differences in geometry. Therefore, a module that fits one brand of wrench will not fit another. This makes the goal of manufacturing a ratchet module to work with any, or even most, wrenches problematic and cost prohibitive.

One embodiment of the present invention is an armature with an elastomeric seating grip which will fit within the jaws of any adjustable wrench. A ratchet head may be secured on the armature. Keying structures may be used to hold pieces of the armature together and within the wrench. The elastomeric grip will also grip jaws of the wrench to further secure the adapter.

Another embodiment of the present invention is a modular ratchet adapter designed to interface with any adjustable wrench using an adaptive grip housing which interfaces with a particular brand and geometry of adjustable wrench with the modular adapter of the earlier patent application. Multiple grip housings may be manufactured for the various geometries of wrenches and an appropriate grip housing fit upon a generic adapter for use with a specific wrench. The present invention represents a departure from the prior art in that the adapter of the present invention allows for less expensive adaptability of the current module product to adapt to different wrenches for use therewith.

### DISCLOSURE OF THE INVENTION

In view of the foregoing disadvantages inherent in the known types of ratchet adapters, an improved ratchet adapter may provide a an adapter which may be modified to accommodate use with any wrench and meets the following objectives: that it be relatively inexpensive to manufacture, that adapting to a specific wrench would be easily accomplished, that the grip housing modules be sturdy enough to withstand normal wear-and-tear of continued use, and that individual grip housings could be mass manufactured at low cost. As such, a new and improved ratchet may comprise a polymer grip housing fit about the ratchet module of the previous application, or any similar module, and thereby adapt the module for secure use within the jaws of an adjustable wrench or similar tool to accomplish these objectives.

The more notable features of the invention have thus been outlined in order that the more detailed description that follows may be better understood and in order that the present contribution to the art may better be appreciated.

Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in many ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

To describe the way the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a perspective view of one embodiment of the adapter module in use with an adjustable wrench;

FIG. 2 is an alternate perspective view of the adapter module of FIG. 1, with alternate ratchet adapters;

FIG. 3 is a side elevation of the adapter module and wrench of FIG. 1.

FIG. 4 is a rear elevation of the adapter module and wrench of FIG. 1;

FIG. 5 is an alternate perspective view of the adapter module and wrench of FIG. 1, separated.

FIG. 6 is a side elevation of the adapter module and wrench of FIG. 5;

FIG. 7 is a sectional view of the adapter and wrench of FIG. 3, taken along line VII-VII.

FIG. 8 is a sectional view of the adapter and wrench of FIG. 4, taken along line VIII-VIII.

FIG. 9 is a series of sectional views of the adapter module in use with different wrenches, in the same plane as FIG. 8.

FIG. 10 is an exploded view of the adapter module of FIG. 5;

FIG. 11 is an alternate exploded view of the adapter module of FIG. 10;

FIG. 12 is a semi-transparent perspective view of the armature pieces used in the adapter module of FIG. 10;

FIG. 13A is a side elevation showing a first stage of an adapter and wrench being assembled together.

FIG. 13B is a side elevation showing a first stage of an adapter and wrench being assembled together.

FIG. 13C is a side elevation showing a first stage of an adapter and wrench being assembled together.

FIG. 14 is a perspective view of an alternate embodiment of a ratchet adapter according to the teachings of the invention;

FIG. 15 is a perspective view the ratchet adapter of FIG. 14 in use with an adjustable wrench;

FIG. 16 is an alternate perspective view of the adapter and wrench of FIG. 15;

FIG. 17 is a perspective view of the adapter and wrench of FIG. 15, assembled;

FIG. 18 is an alternate perspective view of the adapter wrench of FIG. 17;

FIG. 19 is a sectional view of the adapter and wrench of FIG. 17;

FIG. 20 is an exploded view of the adapter of FIG. 14;

FIG. 21 is a perspective view of a tool bit being affixed to the adapter and wrench of FIG. 17.

### LIST OF REFERENCE NUMERALS

The following reference numerals are used throughout the Specification and Drawings:
100—a first embodiment of an adapter module;
110—attachment grip;
115—grip spur indicator;
120—interface spur;
130—trough within attachment grip;
140—first half of adapter armature;
145—armature key structure;
147—armature connection bolt bore;
150—second half of adapter armature;
155—armature key slot;
160—ratchet head;
180—ratchet selector switch;
190—ratchet attachment stud;
200—adjustable wrench;
210—wrench maxilla jaw;
220—adjustment groove;
230—wrench mandible jaw;
240a-240e—ratchet bit attachments;
300—alternate adjustable wrench;
320—alternate adjustment groove;
400—second alternate adjustable wrench;
420—second alternate adjustment groove;
1100—second embodiment of adapter module;
1110—adapter grip housing;
1120—interface spur;
1130—exterior grip housing trough;
1140—interior grip housing trough;
1160—ratchet module;
1170—ratchet control knob;
1180—ratchet selector pawl;
1190—ratchet attachment lip.

### BEST MODES FOR CARRYING OUT THE INVENTION

With reference now to the drawings, a preferred embodiment of the ratchet adapter is herein described. It should be noted that the articles “a,” “an,” and “the,” as used in this specification, include plural referents unless the content clearly dictates otherwise.

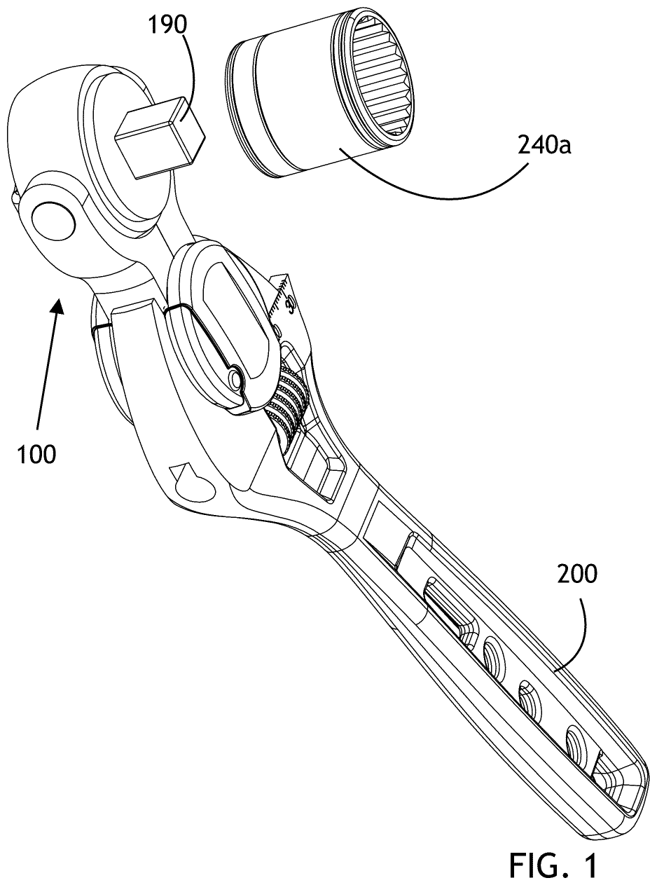

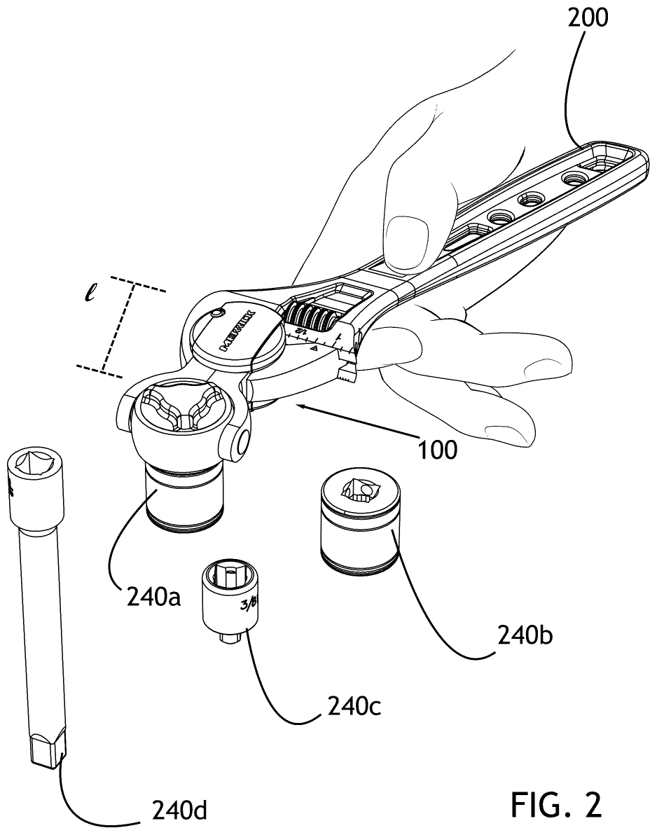

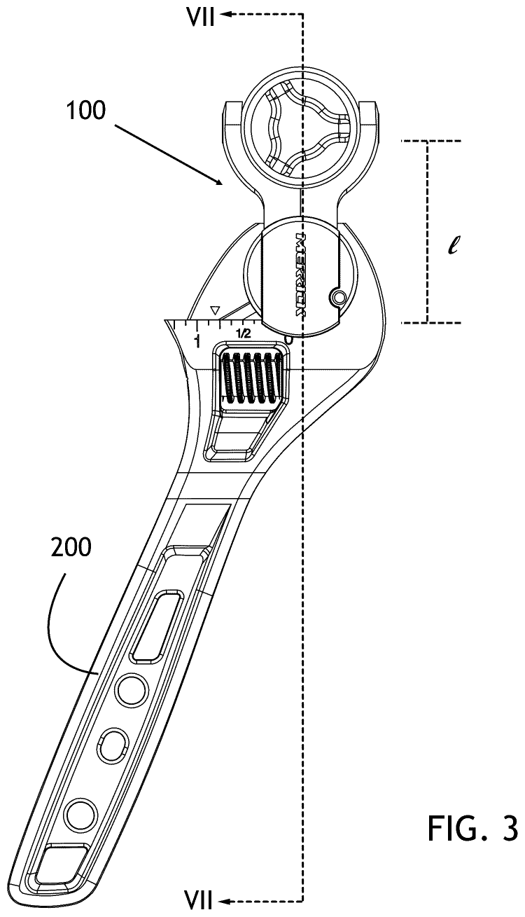

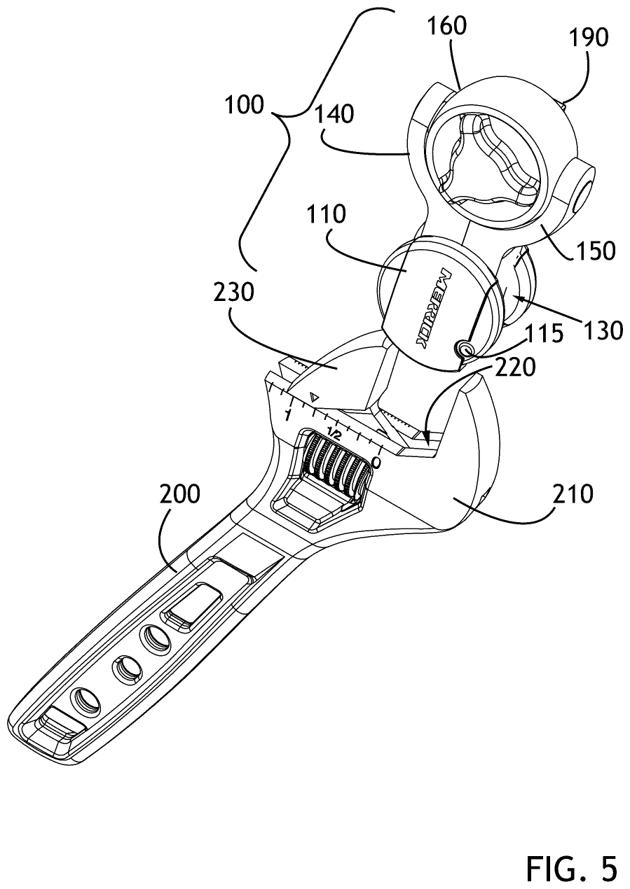

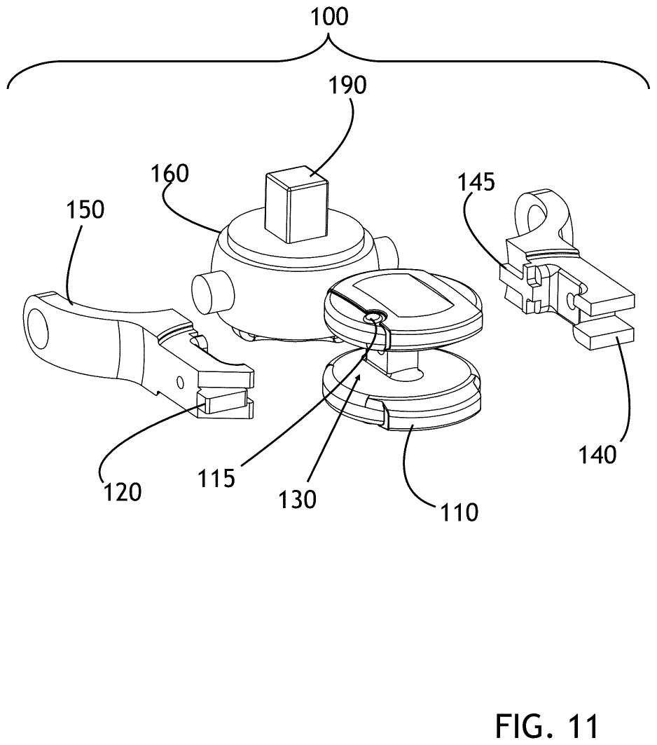

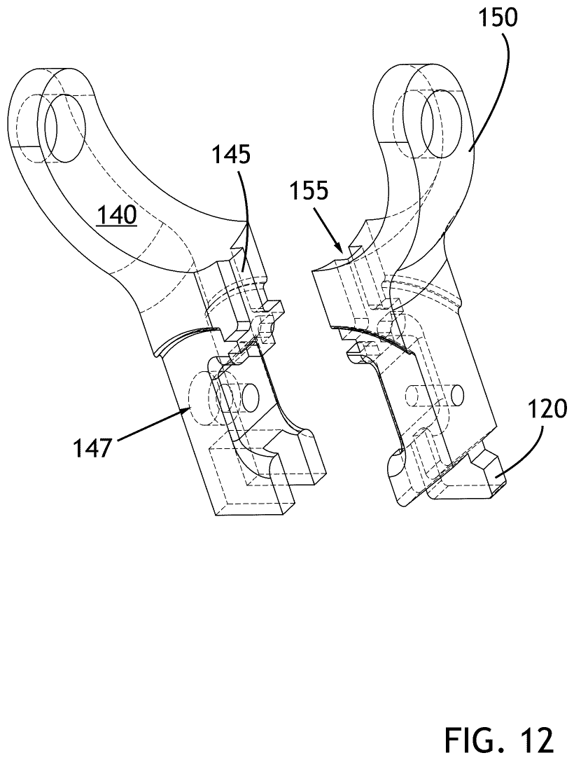

A first embodiment of the invention is disclosed in FIGS. 1-13. In this embodiment, the adapter (100) fits within the jaws of an adjustable wrench (200) and presents a connector (190) for use with a modular tool, such as a ratchet or other tool bit (240a), as is shown in FIG. 1. It should be understood that multiple bits (240a), (240b), or adapters (240c), (240d) are usable with this invention, as the ideal use is to provide a modular system that will replace a multitude of tools with a simple head adapter (100) in conjunction with one of the most common tools found in households, workshops, or other common locations, the adjustable wrench (200) (FIG. 2). This first embodiment is preferred as it increases the length of the tool by a set amount (l), as shown in FIGS. 2 and 3. This increase in length, depending upon the angles and direction of force applied on the base tool, can increase the torque which may be applied to a given object by approximately 25%, assuming an 8-inch (20.3 cm) wrench and a 2-inch (5.0 cm) adapter.

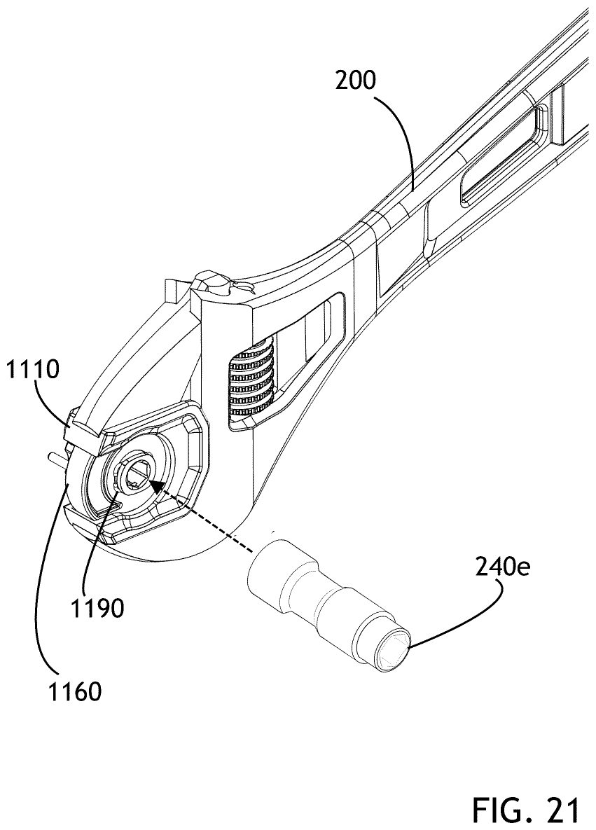

As shown in FIG. 2, the ratchet module (160) may have any type of interface by which to connect tool bits (240a), (240b), (240c), (240d), sockets or other useful items. The second illustrated interface is a lip (1190) over which each bit (240e) may be friction or spring fit (FIG. 21). The manner of attachment may be any conceived by a designer and still fall within the purview of the invention.

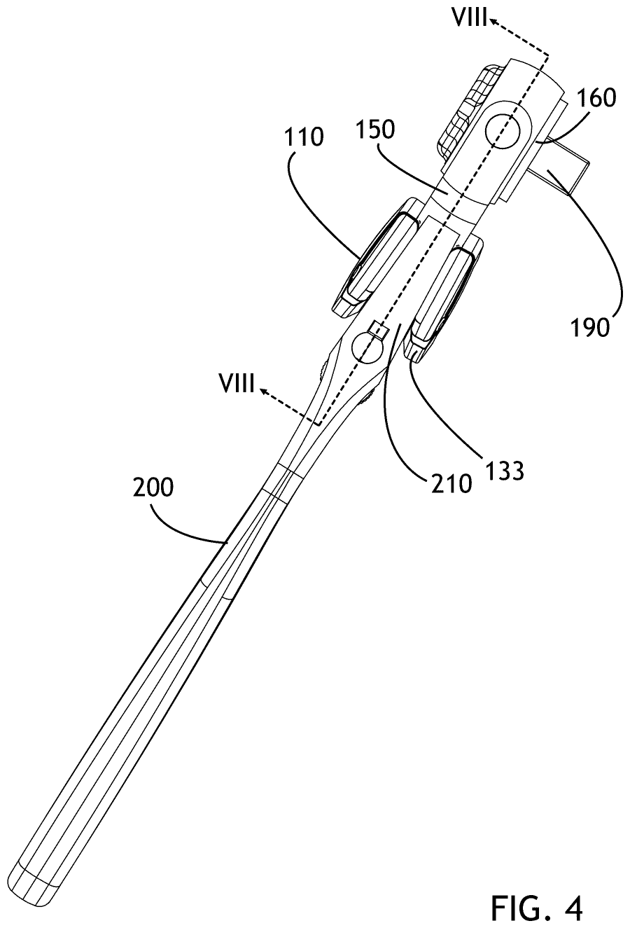

In the first embodiment (FIGS. 4-6), jaws of the wrench (210), (230) are fit within a trough (130) featured within the attachment grip (110) of the adapter. Two halves of a split wishbone armature (140), (150) are positioned within the grip trough (130) and support the ratchet head (160) between the arms of the wishbone. Together, these components form a “ratchet assembly”. Ratchet head may have any of the conventional featured of a ratchet, including a directional control (180) and an interface for bit attachment (190). In the illustrated embodiment, the ratchet head (160) may rotate within the wishbone of the armature for enhanced user control.

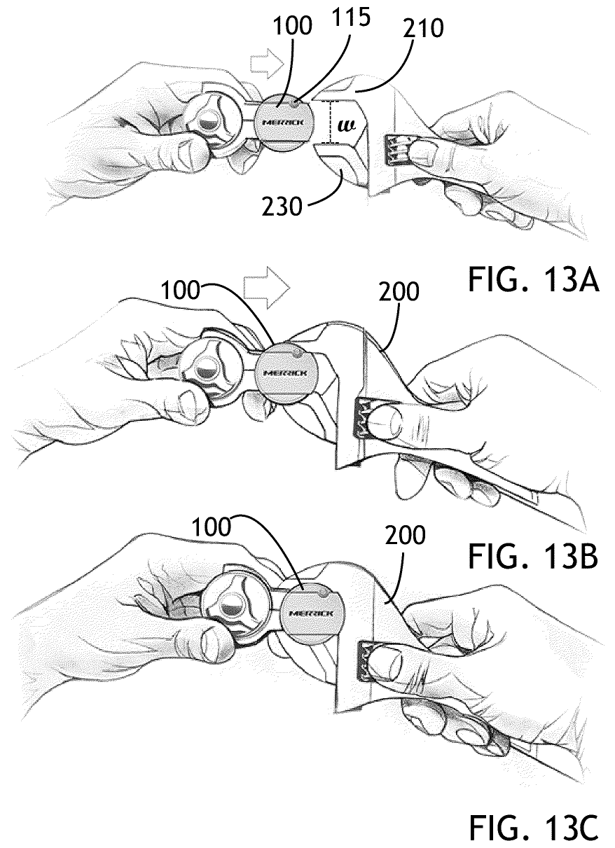

The grip (110) is essentially a wheel-type shape with two opposed rims (133) and a center pedestal (135) defining the trough (130). The grip (110) is made of an elastomeric material and is designed so that the opposed rims (133) will accommodate and grip the jaws (210), (230) of the wrench when installed. This gripping feature allows the adapter to be utilized with diverse wrench designs as the grip will grip different thicknesses of wrench jaws, so long as the jaws are wider than the trough (130). While a range of hardness of the material may be used, a grip (110) with a Shore A durometer of about 70 (+/−10) should be sufficient for most purposes. When installing the adapter (FIGS. 13A, 13B, 13C), the edges of the rims (133) will be somewhat deformed by the jaws (210), (230). The resilient nature of the grip material will then help hold the adapter (100) in place (FIG. 4). This action also self-centers the adapter (100) within the jaws of the wrench (200).

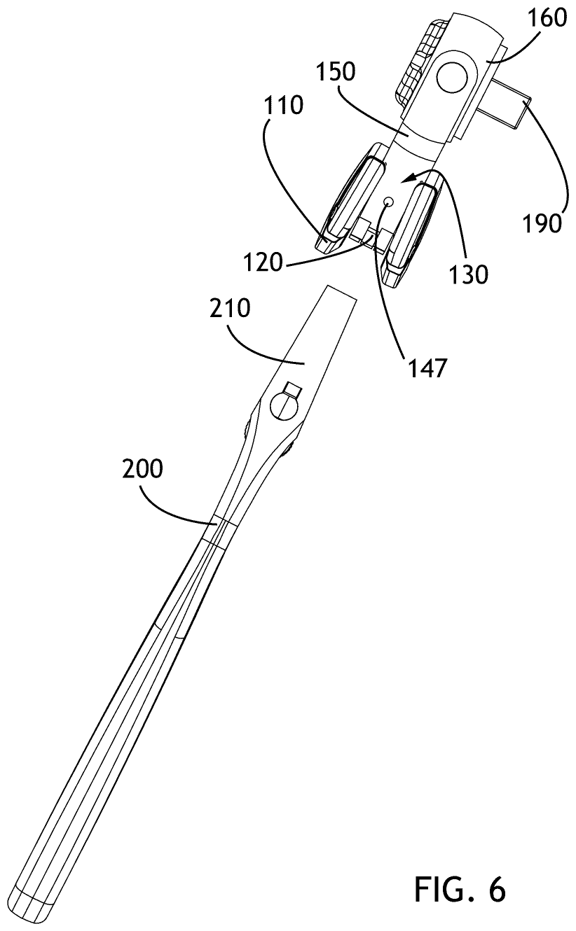

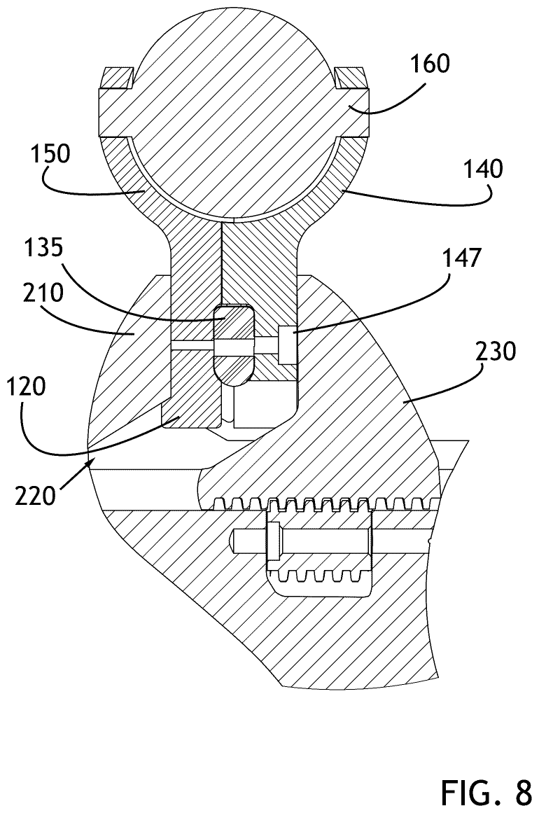

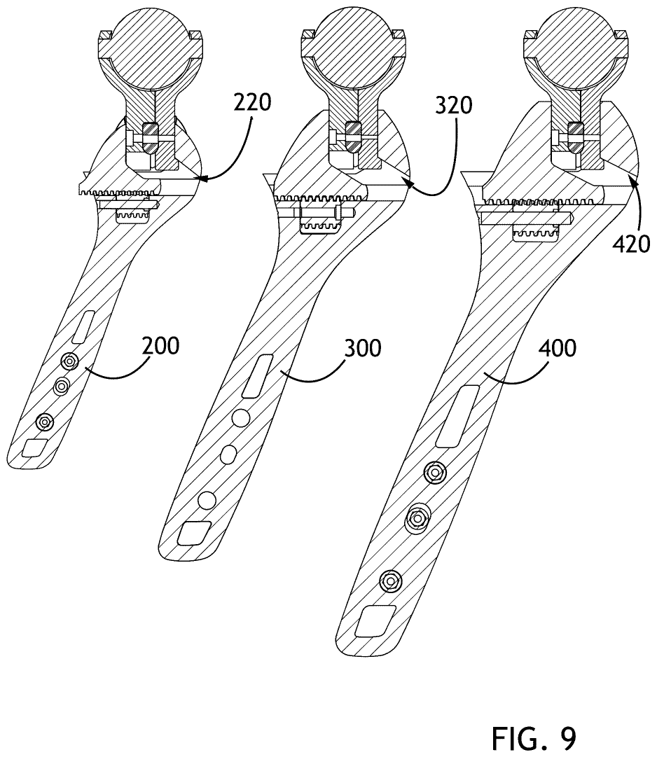

The adapter (100) is also held in place thought the interaction of an interface spur (120) on one of the sides of the armature (150) (FIGS. 6 and 8). This interface spur (120) is designed to fit within a groove (220) formed by the interface of jaws (210), (230) of adjustable wrench (200) when the adapter (100) is positioned there between. This interface spur (120) serves to stabilize the ratchet adapter (100) between the jaws during use and prevent the adapter from slipping out from between the jaws. As can be seen in FIG. 9, this groove (220) is a common feature (320), (420) in all adjustable wrench designs (300), (400).

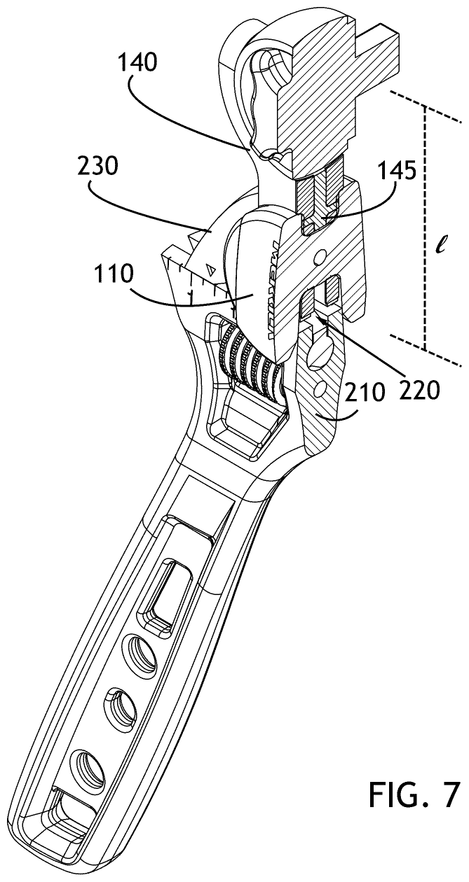

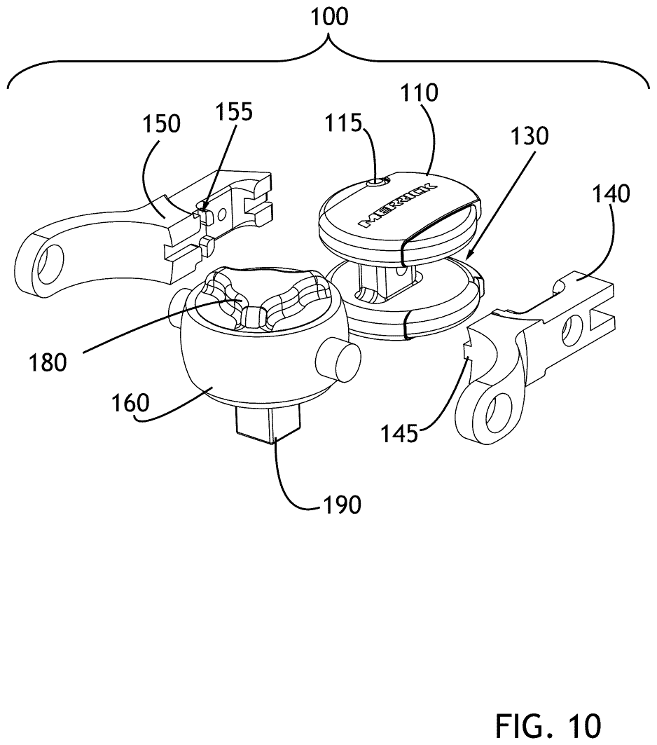

The construction of the adapter (100), shown in FIGS. 10-12, is a simple wishbone armature divided in two halves (140), (150) which are connected about the grip (110) about its pedestal (135) and within its groove (130). One of the armature halves, in this case side (150) should present the interface spur (120). The halves of the armature (140), (150) may be connected by one or more bolts (positioned in bore 147) (FIG. 8) to secure them about the pedestal (135) of the grip (110). As flexibility is required, having a single fixed point of connection that serves all axes, while having other connection which only serves two, is advantageous. To this end, a two-axis keying structure is also provided. Any shape may be utilized which interlaces the armature halves (140), (150) along two axes, such as the cross-shape (145) and interfacing slot (155) shown in FIGS. 7, 10, and 11. In this way, the armature halves (140), (150), are secured against rotation along their shared x-y plane while they may also be tilted on a z-axis, roughly parallel to bolt bore (147), with respect to each other as different shaped jaws are applied thereto. Any suitable shape which will interface the halves on two axes may be used, not merely the illustrated cross-shape. Also, the keying structure (145) and slot (155) are interchangeable depending on which half they may be located.

Positioning of the adapter (100) on a wrench (200) is shown in stages in FIGS. 13A, 13B, and 13C. In preparation, the wrench jaws (210) and (230) are separated by a width (w) which at least roughly corresponds to an internal width within the adapter (110). Indication of an appropriate width and direction may be indicated on the surface of the grip (110). In the illustrated embodiment, a dot indicator (115) is provided to show which side of the adapter (100) has the interface spur. Other indications include the ridges along the surface of the grip, which may follow the internal structure of the grip (100) and serve not only as guidance for the appropriate width (w), but also the direction for aligning the wrench (200) and adapter (100). Setting an appropriate width (w) is important as the adapter (100) is designed to slide onto the wrench (200) (FIG. 13B) with a certain degree of friction to provide positive feedback as to position and to aid in interfacing the adapter (100) and wrench (200). Having too large of a width (w) causes the adapter to be loosely positioned, usually against one jaw of the wrench. The user must then tighten the jaws over one side of the adapter, compressing the rims across a larger surface area until they slip over the jaw, all the while probably not locating the adapter properly in relation to the jaws. Presetting width (w) allows the user to know that the adapter (100) is properly positioned within the jaws and positions both jaws within the grip so that when insertion is completed (FIG. 13C), any further adjustments to the wrench jaws are minimal and are already within the trough of the compressive grip (110). Location indicators, such as dot (115) and the ridges, may take any form, or may be omitted altogether.

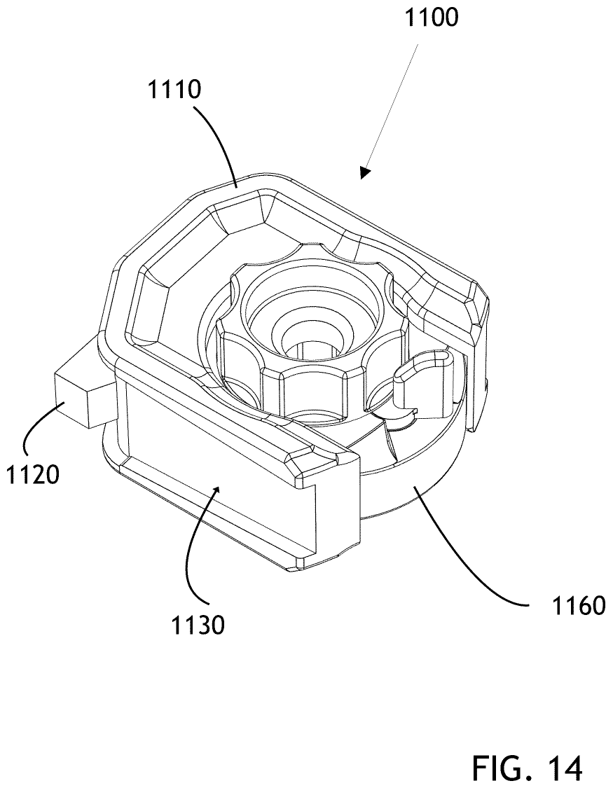

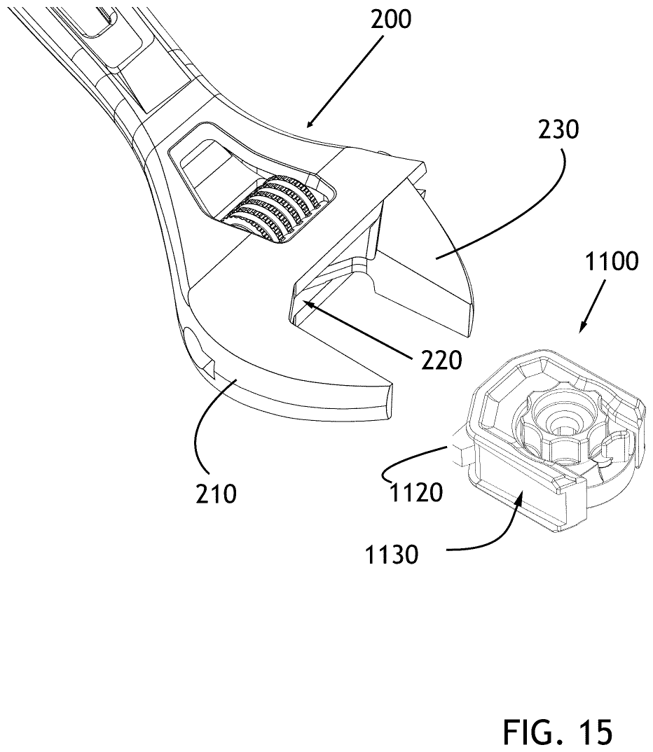

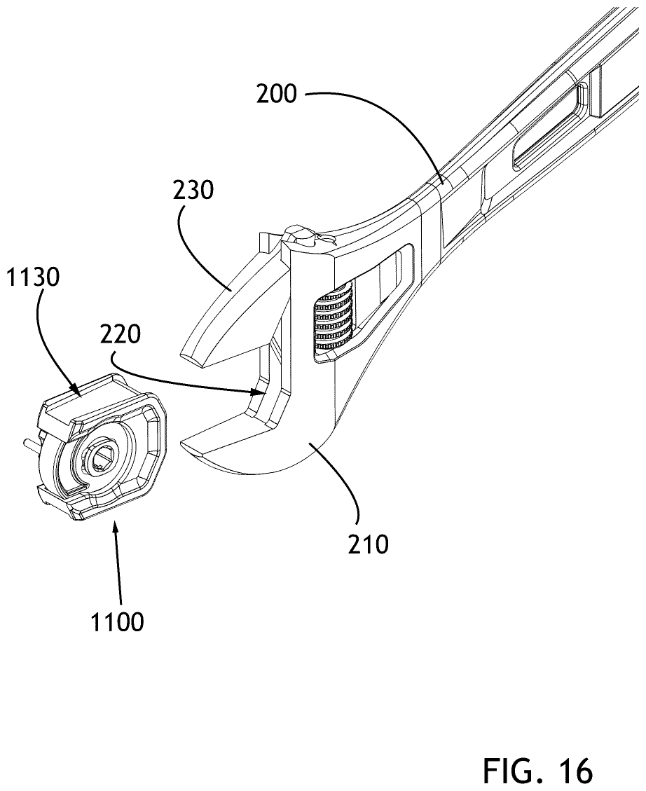

With reference to FIGS. 14-16, an alternate ratchet adapter (1100) may be constructed of two components. The first component is a ratchet module (1160) which may be like the ratchet module described in the earlier referenced PCT application and corresponds to a fusion of the armature (140), (150) and ratchet head (160) of the previous embodiment into a unitary ratchet assembly. The second component is a grip housing (1110) adapted to receive the ratchet module (1160) and fit within the jaws of an adjustable wrench (200). This grip housing (1110) corresponds to the grip (110) of the first embodiment. The ideal grip housing (1110) surrounds three sides of adapter (1160), defining a U-shape, and features an exterior trough (1130) on its three extant sides. As with the first embodiment, interface spur (1120) should also be provided at one of the bottom corners of the grip housing (1110).

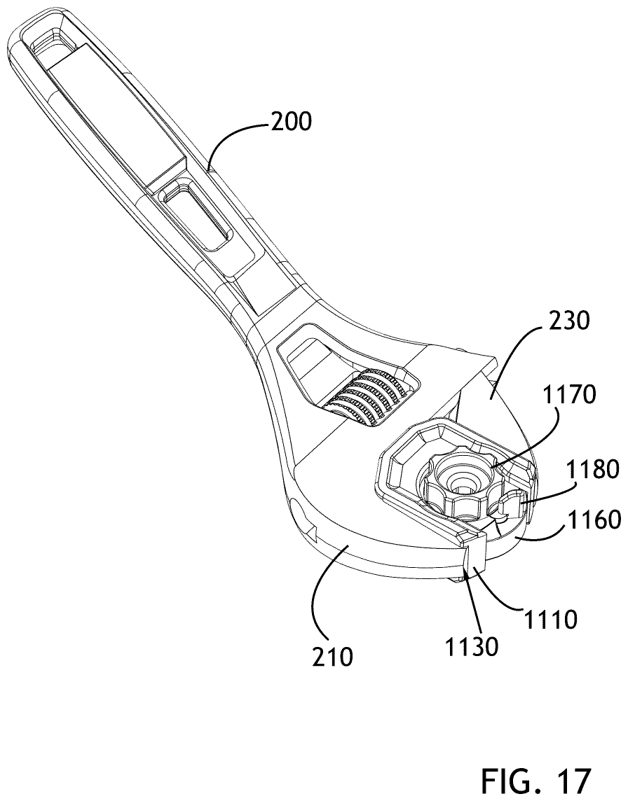

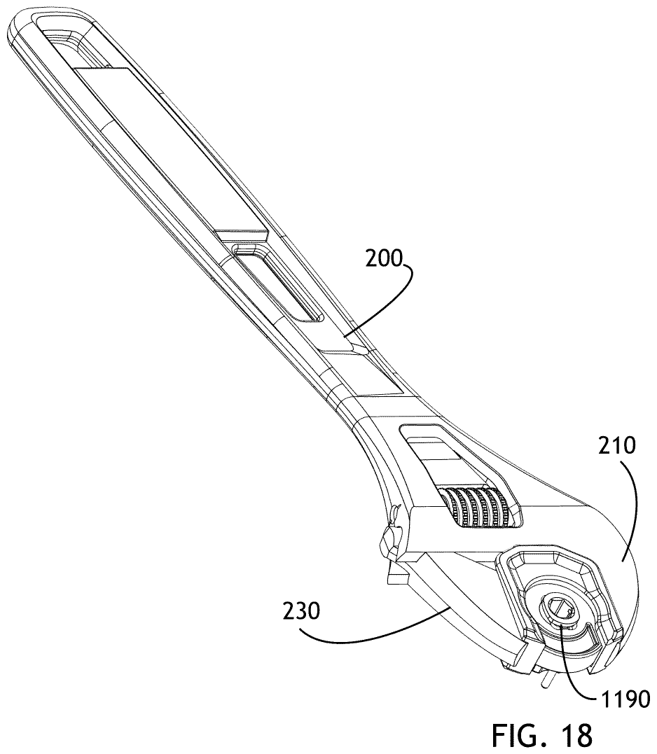

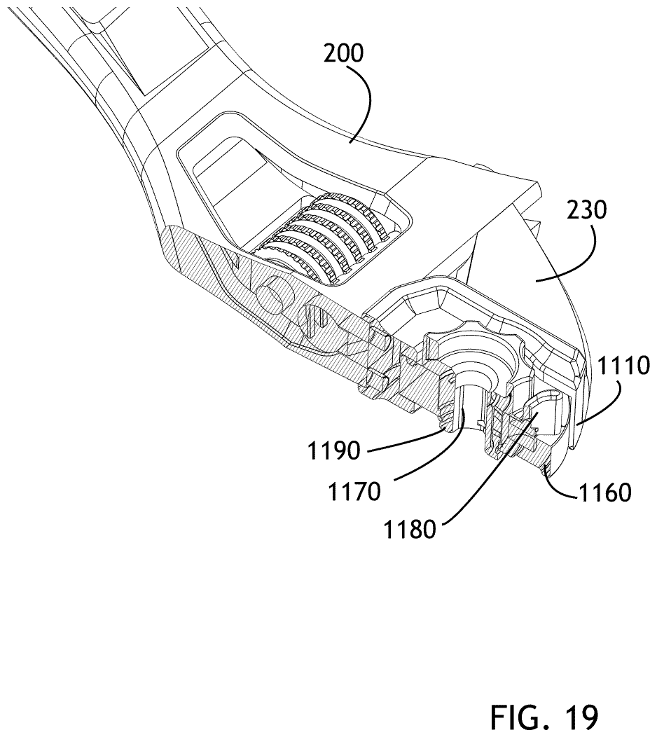

In use, shown in FIGS. 17-19, the ratchet adapter (1100) is positioned between jaws (210), (230) with interface spur (1120) inserted with in groove (220) and the jaws (210), (230) being tightened about grip housing (1110) until they rest with in trough (1130). This arrangement forces the lower portion of trough (1130) over the groove (220) and the wrench between jaws (210), (230), thereby providing three points of contact with a further keyed interface. The adapted wrench (200) may then be used as a ratchet with any features the module (1160) has, including a ratchet control (1170) and a direction pawl (1180).

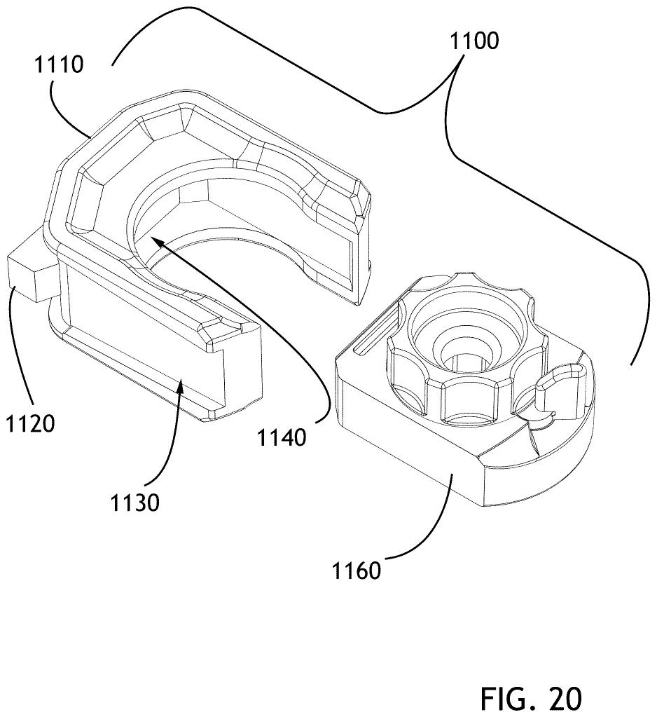

As shown in FIG. 20, the ratchet module (1160) fits within an inner trough (1140) formed to between the arms of the grip housing (1110). In this manner a single module (1160) may be manufactured for all platforms. The grip housing (1110) is then made to receive the module (1160) and this portion of its geometry may also be consistent across all platforms. The exterior geometry, however, is made to comport with a given brand and size of adjustable wrench. It should also be noted that the grip housing (1110) and the module (1160) should be permanently connected when assembled. This creates a more rugged and sturdy interface between the two components. This is especially important given that the tool may be used in some form of working environment. This preference does not preclude an interface between the two components which is not permanent, it is merely a preference.

For this alternate embodiment, there is a preference for manufacture from rugged and durable materials. Metals are particularly preferred for the ratchet module (1160) while durable polymers, which may be easily and quickly molded to a specified design, are preferred for the grip housing (1110). These preferences, however, do not limit the invention as to its construction.

### INDUSTRIAL APPLICABILITY

The present invention has industrial applicability in that it may be produced by industry and has usefulness in the home maintenance, vehicle mechanics, and other fields. Although the present invention has been described with reference to preferred embodiments, numerous modifications and variations can be made and still the result will come within the scope of the invention. The described embodiments are to be considered in all respects only as illustrative and not restrictive. Likewise, the preferred tool for use with the adapter in either of the described embodiments is an adjustable wrench (200) but this does not preclude use and adaptation for any other tool, particularly if it features two opposed jaws which may be secured in relation to each other. This type of tool would include pliers and vice grips, and all similar tools should be considered included in the term “wrench” when reading the Specification and appended claims. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

1. A modular tool adapter for an opposed-jaw tool, the adapter comprising:
an elastomeric grip, said elastomeric grip further comprising a pedestal and two opposed rims defining a trough; and
a ratchet assembly insertable within said grip;
wherein the grip holds the ratchet assembly and is held between opposed jaws of the tool and the opposed jaws of the tool are secured within the trough and the opposed rims will conform to the opposed jaws if the opposed jaws have a width greater than a width of the trough.

2. The modular tool adapter of claim 1, the ratchet assembly thereof further comprising a two-part armature which supports a tool head.

3. The modular tool adapter of claim 2, the two-part armature further comprising an interface spur designed to interface with the tool.

4. The modular tool adapter of claim 3 further comprising indicia to identify a location of the interface spur.

5. The modular tool adapter of claim 4, the two parts of the armature being keyed together in two axes, with some flexure being allowed along a third axis.

6. The modular tool adapter of claim 5, the two parts of the armature being fastened about the pedestal within the trough.

7. The modular tool adapter of claim 2, the two parts of the armature being keyed together in two axes, with some flexure being allowed along a third axis.

8. The modular tool adapter of claim 7, the two parts of the armature being fastened about the pedestal within the trough.

9. The modular tool adapter of claim 2, the two parts of the armature being fastened about the pedestal within the trough.

10. The modular tool adapter of claim 1, the ratchet assembly thereof further comprising an interface spur designed to interface with the tool.

11. The modular tool adapter of claim 10 further comprising indicia to identify a location of the interface spur.

12. The modular tool adapter of claim 11, further comprising an armature fastened about the grip pedestal and supporting a tool head.

13. The modular tool adapter of claim 10, further comprising an armature fastened about the grip pedestal and supporting a tool head.

14. (canceled)

15. The modular tool adapter of claim 1, the grip having a Shore A durometer of between 60 and 80 inclusively.
